(19) United States
(12) Patent Application Publication
(10) Pub. No.: US 2023/0267506 A1
(43) Pub. Date: Aug. 24, 2023

(54) MATCHING DEVICE, SALES PROMOTION ASSISTANCE SYSTEM, MATCHING METHOD, AND NON-TRANSITORY COMPUTER-READABLE MEDIUM

(71) Applicant: NEC Corporation, Minato-ku, Tokyo (JP)

(72) Inventors: Masahiro TANI, Tokyo (JP); Kazufumi KOJIMA, Tokyo (JP); Keisuke IKEDA, Tokyo (JP)

(73) Assignee: NEC Corporation, Minato-ku, Tokyo (JP)

(21) Appl. No.: 18/011,318

(22) PCT Filed: Jun. 22, 2020
(86) PCT No.: PCT/JP2020/024317

§ 371 Date: Dec. 19, 2022

(51) Int. Cl. G06Q 30/0251; G06Q 50/00

(52) U.S. Cl. CPC G06Q 30/0269; G06Q 50/01

(57) ABSTRACT

A matching device (10) includes: a cyber attribute extraction unit (11) that extracts, based on social media information of a plurality of accounts, a plurality of pieces of cyber attribute information being personal attributes in a cyberspace of the plurality of accounts; a physical attribute extraction unit (12) that extracts, based on an image acquired by capturing a real world, physical attribute information being a personal attribute in a physical space of a person in the image; a calculation unit (13) that calculates a degree of agreement between the plurality of pieces of extracted cyber attribute information and the extracted physical attribute information; and an output unit (14) that compares a piece of cyber attribute information selected based on the degree of agreement among the plurality of pieces of cyber attribute information with the physical attribute information, and outputs a result of the comparison.

### TECHNICAL FIELD

The present invention relates to a matching device, a sales promotion assistance system, a matching method, and a non-transitory computer-readable medium.

### BACKGROUND ART

In recent years, diversification of customers in retail has advanced, and it has become difficult to determine a purchase tendency and behavior of customers. Therefore, a marketing concept called Online Merges with Offline (OMO) that links offline information in a real world (physical space) and on-line information in a cyber world (cyberspace) has been permeated. The OMO is a technique of maximizing customer experience, by converting into data and aggregating customer attributes and behavior without barriers between the real world and the cyber world, and analyzing the aggregated data.

As a related technique, for example, Patent Literature 1 is known. Patent Literature 1 describes that an action history of a person in the cyber world on the Internet and an action history of a person in an actual store are integrated.

### CITATION LIST

### Patent Literature

[Patent Literature 1] International Patent Publication No. WO 2020/008938

### SUMMARY OF INVENTION

### Technical Problem

As described above, information of a person in a physical space and information of a person in a cyberspace are integrated for marketing in the related technique. However, in the related technique, it is difficult to appropriately recognize information of a person in the cyberspace related to a person in the physical space.

In view of such a problem, an object of the present disclosure is to provide a matching device, a sales promotion assistance system, a matching method, and a non-transitory computer-readable medium that are capable of appropriately recognizing information of a person in a cyberspace related to a person in a physical space.

### Solution to Problem

A matching device according to the present disclosure includes: a cyber attribute extraction means for extracting, based on social media information of a plurality of accounts, a plurality of pieces of cyber attribute information being personal attributes in a cyberspace of the plurality of accounts; a physical attribute extraction means for extracting, based on an image acquired by capturing a real world, physical attribute information being a personal attribute in a physical space of a person in the image; a calculation means for calculating a degree of agreement between the plurality of pieces of extracted cyber attribute information and the extracted physical attribute information; and an output means for comparing a piece of cyber attribute information selected based on the degree of agreement among the plurality of pieces of cyber attribute information with the physical attribute information, and outputting the compared result.

A sales promotion assistance system according to the present disclosure includes an imaging device installed in a store, and a matching device, wherein the matching device includes: a cyber attribute extraction means for extracting, based on social media information of a plurality of accounts, a plurality of pieces of cyber attribute information being personal attributes in a cyberspace of the plurality of accounts; a physical attribute extraction means for extracting, based on an image captured by the imaging device, physical attribute information being a personal attribute in a physical space of a person in the image; a calculation means for calculating a degree of agreement between the plurality of pieces of extracted cyber attribute information and the extracted physical attribute information; and an output means for comparing a piece of cyber attribute information selected based on the degree of agreement among the plurality of pieces of cyber attribute information with the physical attribute information, and outputting the compared result.

A matching method according to the present disclosure includes: extracting, based on social media information of a plurality of accounts, a plurality of pieces of cyber attribute information being personal attributes in a cyberspace of the plurality of accounts; extracting, based on an image acquired by capturing a real world, physical attribute information being a personal attribute in a physical space of a person in the image; calculating a degree of agreement between the plurality of pieces of extracted cyber attribute information and the extracted physical attribute information; comparing a piece of cyber attribute information selected based on the degree of agreement among the plurality of pieces of cyber attribute information with the physical attribute information; and outputting the compared result.

A non-transitory computer-readable medium according to the present disclosure is a non-transitory computer-readable medium storing a program for causing a computer to execute processing of: extracting, based on social media information of a plurality of accounts, a plurality of pieces of cyber attribute information being personal attributes in a cyberspace of the plurality of accounts; extracting, based on an image acquired by capturing a real world, physical attribute information being a personal attribute in a physical space of a person in the image; calculating a degree of agreement between the plurality of pieces of extracted cyber attribute information and the extracted physical attribute information; comparing a piece of cyber attribute information selected based on the degree of agreement among the plurality of pieces of cyber attribute information with the physical attribute information; and outputting the compared result.

### Advantageous Effects of Invention

According to the present disclosure, it is possible to provide a matching device, a sales promotion assistance system, a matching method, and a non-transitory computer-readable medium that are capable of appropriately recognizing information of a person in a cyberspace related to a person in a physical space.

### BRIEF DESCRIPTION OF DRAWINGS

FIG. 1 is a configuration diagram illustrating an outline of a matching device according to an example embodiment;

FIG. 2 is a configuration diagram illustrating a configuration example of a sales promotion assistance system according to a first example embodiment;

FIG. 3 is a flowchart illustrating an operation example of the sales promotion assistance system according to the first example embodiment;

FIG. 4 is a flowchart illustrating an operation example of cyber attribute extraction processing according to the first example embodiment;

FIG. 5 is a diagram illustrating a specific example of cyber attribute information according to the first example embodiment;

FIG. 6 is a diagram illustrating a specific example of cyber attribute information according to the first example embodiment;

FIG. 7 is a diagram illustrating a specific example of cyber attribute information according to the first example embodiment;

FIG. 8 is a flowchart illustrating an operation example of physical attribute extraction processing according to the first example embodiment;

FIG. 9 is a diagram illustrating a specific example of physical attribute information according to the first example embodiment;

FIG. 10 is a diagram illustrating a specific example of physical attribute information according to the first example embodiment;

FIG. 11 is a diagram illustrating a specific example of physical attribute information according to the first example embodiment;

FIG. 12 is a diagram illustrating specific examples of physical attribute information and cyber attribute information according to the first example embodiment;

FIG. 13 is a flowchart illustrating an operation example of cyber attribute extraction processing according to a second example embodiment;

FIG. 14 is a specific example of cyber attribute information according to the second example embodiment;

FIG. 15 is a flowchart illustrating an operation example of physical attribute extraction processing according to the second example embodiment;

FIG. 16 is a diagram illustrating a specific example of physical attribute information according to the second example embodiment;

FIG. 17 is a diagram illustrating a specific example of cyber attribute information according to a third example embodiment;

FIG. 18 is a diagram illustrating a specific example of physical attribute information according to the third example embodiment;

FIG. 19 is a configuration diagram illustrating a configuration example of a sales promotion assistance system according to a fourth example embodiment; and

FIG. 20 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference numerals, and redundant descriptions thereof are omitted as necessary.

### SUMMARY OF EXAMPLE EMBODIMENT

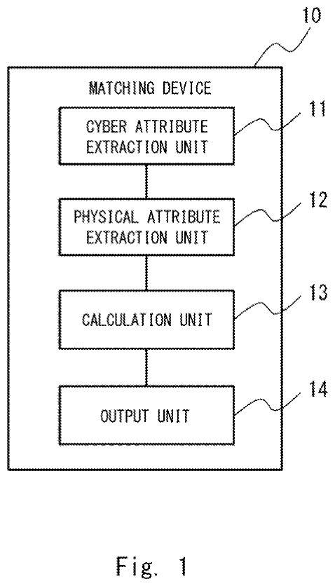

FIG. 1 illustrates an outline of a matching device according to an example embodiment. As illustrated in FIG. 1, a matching device 10 according to the example embodiment includes a cyber attribute extraction unit 11, a physical attribute extraction unit 12, a calculation unit 13, and an output unit 14.

The cyber attribute extraction unit 11 extracts, based on social media information of a plurality of accounts, a plurality of pieces of cyber attribute information, which are personal attributes in a cyberspace of the plurality of accounts. The physical attribute extraction unit 12 extracts, based on an image acquired by capturing a real world, physical attribute information that is a personal attribute in a physical space of a person in the image.

The calculation unit 13 calculates a degree of agreement between the plurality of pieces of cyber attribute information extracted by the cyber attribute extraction unit 11 and the physical attribute information extracted by the physical attribute extraction unit 12. The output unit 14 compares a piece of cyber attribute information selected based on the degree of agreement among the plurality of pieces of cyber attribute information with the physical attribute information, and outputs the compared result. For example, the cyber attribute information and the physical attribute information include attribute items related to sales promotion of a store in the real world, and output information related to a difference or an agreement between the respective attribute items.

In a related technique, information of persons in a physical space is integrated with information of persons in a cyberspace, but it is difficult to perform sales promotion in accordance with customers who actually visit a store. In particular, from a viewpoint of privacy protection, there is a case where it is restricted to acquire individual information from a face of a customer who visits a store, and it is difficult to identify individual information of the customer and perform sales promotion.

Therefore, in the example embodiment, for example, by calculating and comparing the degree of agreement between a physical attribute of a person in an image captured in a store and a cyber attribute of the account of social media, it is possible to appropriately recognize information of the person in the cyberspace related to the person in the physical space. In this way, it is possible to perform sales promotion in accordance with the person in the physical space, by using the information of the person in the related cyberspace while protecting the privacy.

### First Example Embodiment

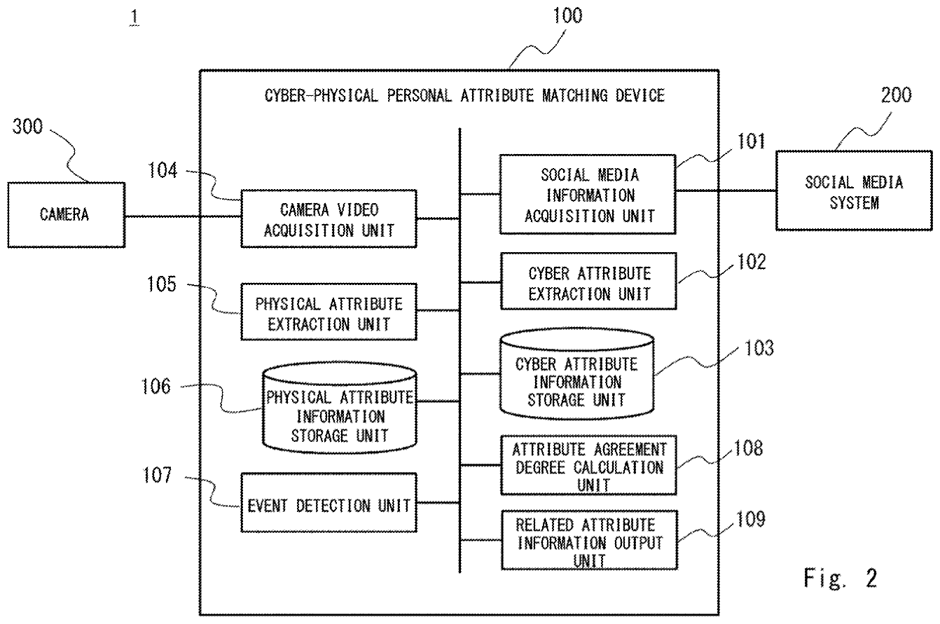

Hereinafter, a first example embodiment will be described with reference to the drawings. FIG. 2 illustrates a configuration example of a sales promotion assistance system according to the present example embodiment. A sales promotion assistance system 1 according to the present example embodiment is a system that assists sales promotion of a retailer by using information of an account of social media and an image of a camera of a store. A target store may be a small-scale retail store, or may be a shopping mall or a department store including a plurality of shops.

As illustrated in FIG. 2, the sales promotion assistance system 1 includes a cyber-physical personal attribute matching device 100, a social media system 200, and a camera 300. Note that the camera 300 and the cyber-physical personal attribute matching device 100 may be one device.

The social media system 200 is a system that provides social media services such as a Social Networking Service (SNS). The social media service is an online service capable of transmitting (publishing) and communicating information between a plurality of accounts (users) over the Internet (online). The social media services include not only SNS but also messaging services such as chat, blogs, electronic bulletin boards, video sharing sites, information sharing sites, social games, social bookmarks, and the like. For example, the social media system 200 includes a server or a user terminal on a cloud. The user terminal inputs and browses posts via an Application Programming Interface (API) to be provided by a server. The social media system 200 and the cyber-physical personal attribute matching device 100 are communicably connected via the Internet or the like.

The camera 300 is a monitoring camera (imaging device) for capturing an image of a customer (person) who has visited a store. The camera 300 is installed at a plurality of locations in the store in order to monitor a behavior of the customer in the store. For example, the camera 300 is installed at an entrance of a store, a display shelf of each commodity, each sales hall, or the like. The camera 300 may be installed not only in a store but also in a parking lot or the like outside the store. The camera 300 and the cyber-physical personal attribute matching device 100 are communicably connected via an optional network.

The cyber-physical personal attribute matching device 100 matches the cyber attribute of the social media account and the physical attribute of a person in a video from the camera, and outputs attribute information based on the matching result, thereby assisting sales promotion to the person.

As illustrated in FIG. 2, the cyber-physical personal attribute matching device 100 includes a social media information acquisition unit 101, a cyber attribute extraction unit 102, a cyber attribute information storage unit 103, a camera video acquisition unit 104, a physical attribute extraction unit 105, a physical attribute information storage unit 106, an event detection unit 107, an attribute agreement degree calculation unit 108, and a related attribute information output unit 109. Note that a configuration of the units (blocks) is an example, and it may be configured by other units as long as an operation (a method) to be described later is possible. The units may be provided in one device or in a plurality of devices. For example, the social media information acquisition unit 101, the cyber attribute extraction unit 102, and the cyber attribute information storage unit 103 may be separate devices.

The social media information acquisition unit 101 acquires (collects) social media information from the social media system 200. The social media information is public information (account information) regarding each account of the social media, and includes profile information, posted information, and the like of the account. The social media information acquisition unit 101 acquires all the social media information that can be acquired from the social media system 200. It may be acquired from a server providing a social media service via an API (acquisition tool) or may be acquired from a database in which social media information is stored in advance.

The cyber attribute extraction unit 102 extracts cyber attribute information of each account, based on the acquired social media information. The cyber attribute extraction unit 102 extracts data (attribute data) of an attribute item related to sales promotion of a store included in the cyber attribute information. The cyber attribute extraction unit 102 extracts the cyber attribute information from the profile information, the posted information, and the like of the account by using text analysis, image analysis technology, or the like, and stores the extracted cyber attribute information in the cyber attribute information storage unit 103. The cyber attribute information storage unit 103 is a storage device that stores the cyber attribute information of all the extracted accounts. The cyber attribute information storage unit 103 is a nonvolatile memory such as a flash memory, a hard disk device, or the like.

The camera image acquisition unit 104 acquires a video including a customer (person) of a store from the camera 300. The camera image acquisition unit 104 acquires a video of a person moving in the store from the camera 300 at any time.

The physical attribute extraction unit 105 extracts, based on a video acquired from the camera 300, a physical attribute of a person in the video. The physical attribute extraction unit 105 extracts data (attribute data) of attribute items related to sales promotion of a store included in physical attribute information. The physical attribute extraction unit 105 extracts physical attribute information from an appearance and an action of the person recognized in the video by using an image analysis technique, an action analysis technique, or the like, and stores the extracted physical attribute information in the physical attribute information storage unit 106. The physical attribute extraction unit 105 updates the physical attribute information as needed depending on movement (action) of the person. In consideration of privacy, it is preferable not to recognize a face of a person, but a necessary attribute may be determined based on the face within a range that does not specify an individual. The physical attribute information storage unit 106 is a storage device that stores the physical attribute information of the extracted person. Like the cyber attribute information storage unit 103, the physical attribute information storage unit 106 is a nonvolatile memory, a hard disk device, or the like.

The event detection unit 107 detects an event (timing) for matching and outputting the physical attribute information and the cyber attribute information. The event to be detected is an event to assist sales promotion, and is a timing at which a person is interested in a product and predicted to purchase the product (has taken a product in hand, is viewing a product, has purchased another related product), a time when a person approaches a display shelf of a product or a sales hall, a time when the person stops therein, or the like.

The attribute agreement degree calculation unit 108 calculates a degree of attribute agreement between the physical attribute information and the plurality of pieces of cyber attribute information. The attribute agreement degree calculation unit 108 refers to the cyber attribute information storage unit 103 and the physical attribute information storage unit 106, and compares the attribute items and the attribute data in the attribute items of the physical attribute information and the plurality of pieces of cyber attribute information. The degree of attribute agreement (or degree of attribute disagreement) indicates a degree (score) of agreement in each attribute item and each piece of attribute data in the attribute item between the physical attribute information and the cyber attribute information.

The related attribute information output unit 109 selects a piece of cyber attribute information related to the physical attribute, based on the calculated degree of attribute agreement, and outputs a comparison result between the selected cyber attribute information and the physical attribute information. One piece of cyber attribute information may be selected, or a plurality of pieces of cyber attribute information may be selected. For example, cyber attribute information having a degree of attribute agreement higher than a predetermined threshold value is selected, and in particular, cyber attribute information having the highest degree of attribute agreement is selected. Not only the cyber attribute information having the highest degree of attribute agreement, but also cyber attribute information including a difference within a predetermined range may be selected. The related attribute information output unit 109 outputs difference information and agreement information between the pieces of the attribute information as for a pair of the selected cyber attribute information and the physical attribute. Any optional method (display, voice, etc.) may be used for outputting as the output method as long as the retailer is available for sales promotion.

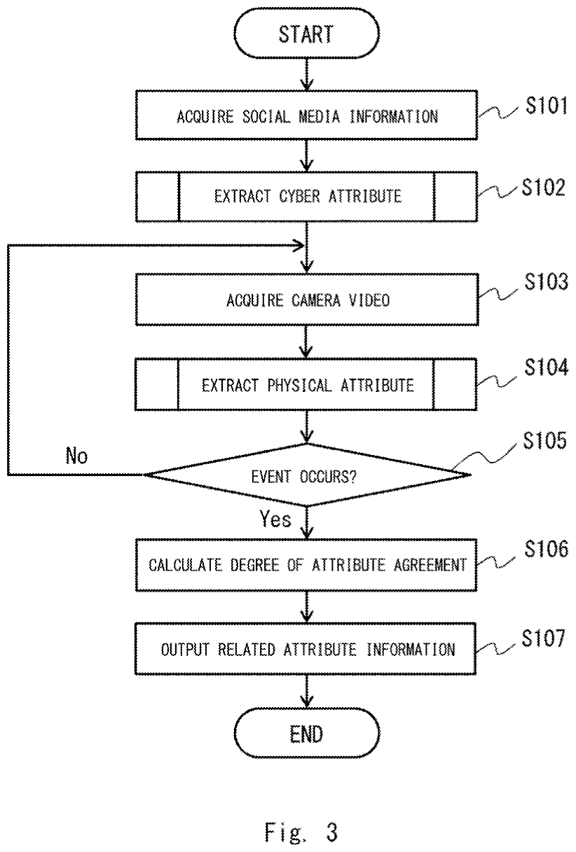

FIG. 3 illustrates an operation example by the sales promotion assistance system (cyber-physical personal attribute matching device) according to the present example embodiment. As illustrated in FIG. 3, the cyber-physical personal attribute matching device 100 first acquires social media information (S101) and performs cyber attribute extraction processing (S102). These processing may be performed before attribute agreement degree calculation processing (S106). For example, the processing may be performed before physical attribute extraction processing (S104) or may be performed simultaneously with the physical attribute extraction processing (S104). Further, the cyber attribute information may be updated by periodically extracting the cyber attribute.

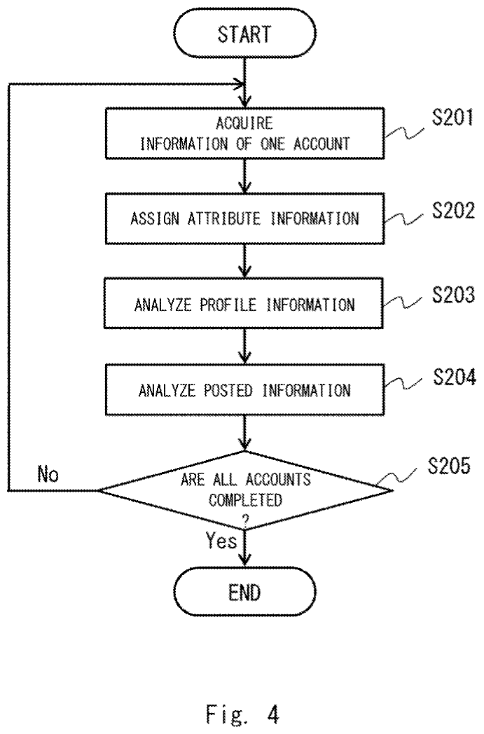

Specifically, the social media information acquisition unit 101 accesses a server or a database of the social media system 200, and acquires social media information of all accounts that are open to the public and can be acquired. For example, the social media information is acquired in a range enabled by an API (acquisition tool) of the social media service. Further, the cyber attribute extraction unit 102 executes cyber attribute extraction processing, based on the acquired social media information. FIG. 4 illustrates a specific example of the cyber attribute extraction processing.

As illustrated in FIG. 4, in the cyber attribute extraction processing, the cyber attribute extraction unit 102 first acquires social media information (account information) of one account from among all the acquired social media information (S201).

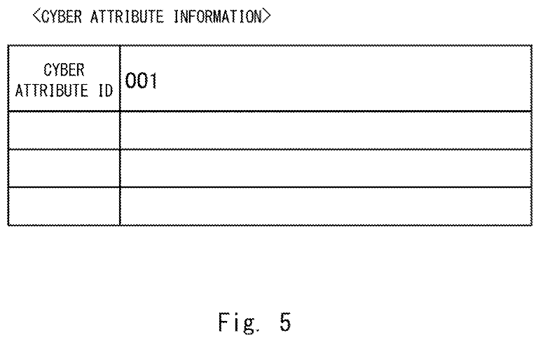

Next, the cyber attribute extraction unit 102 assigns attribute information for the acquired account information of one account (S202). For example, as in FIG. 5, the cyber attribute extraction unit 102 generates cyber attribute information and assigns a cyber attribute ID thereto. Attribute items of the cyber attribute information may not be set first, and be set according to an analysis result, or necessary items may be set in advance. The attribute item set in the cyber attribute information includes an attribute associated to a product of a store. For example, a product list of a store may be held in advance, and an attribute item may be generated in association with the product list. Note that attribute items based on a plurality of products (items) may be included. For example, a lifestyle (brand orientation, etc.) and the like that can be recognized from a plurality of items may be included.

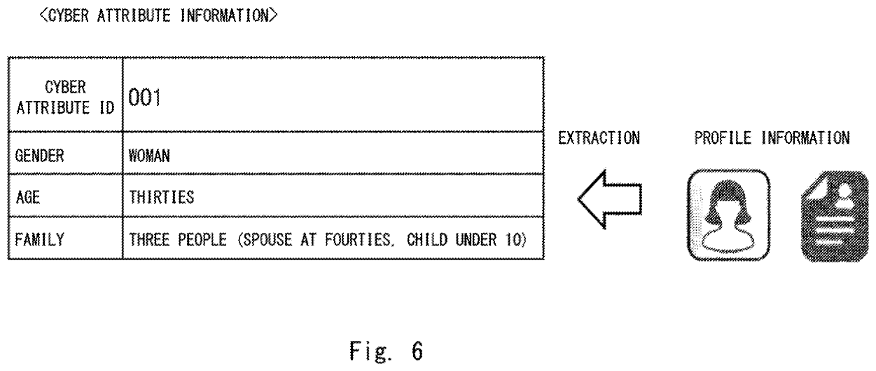

Next, the cyber attribute extraction unit 102 analyzes profile information included in the account information (social media information) (S203). The profile information includes text indicating a profile of an account (a user) and an image of the account, and the cyber attribute extraction unit 102 extracts attribute items and attribute data by performing text analysis or image analysis on these pieces. For example, as in FIG. 6, gender, age, and family are recognized from text and images of the profile information, and these attribute items and attribute data are added to the cyber attribute information. For example, the profile information includes text indicating gender, age, and family, and attribute data are generated based on the text. These pieces of attribute information may be extracted not only from the profile information, but also from posted information or the like. Further, these pieces of attribute information are examples, and other pieces of attribute information (e.g., an activity place, an address, a place of origin, a hobby, an occupation, a school, etc.) may be extracted from the profile information.

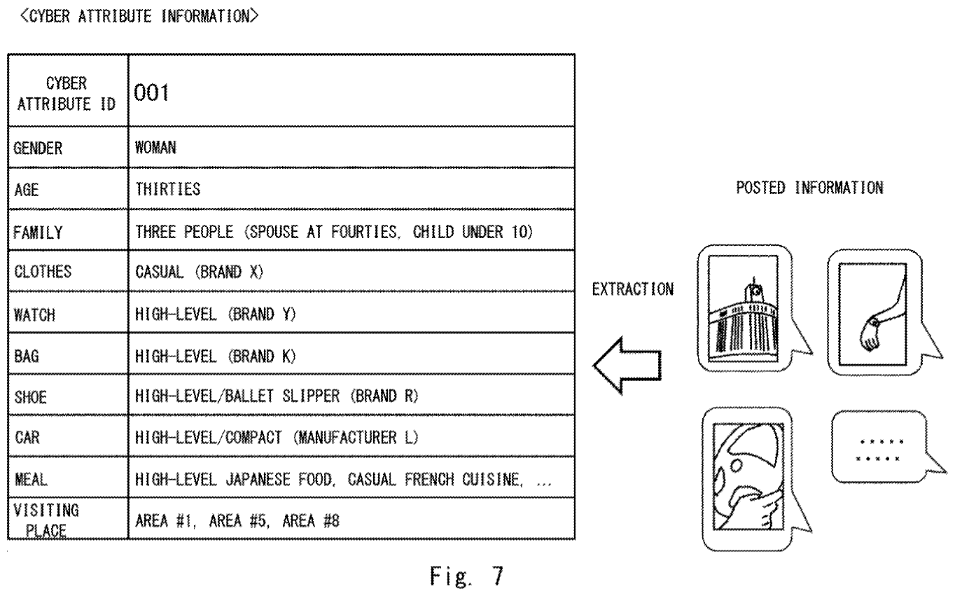

Next, the cyber attribute extraction unit 102 analyzes the posted information included in the account information (social media information) (S204). The posted information includes text and images posted by an account (user) on a timeline or the like, and the cyber attribute extraction unit 102 extracts attribute items and attribute data by performing text analysis and image analysis on these pieces. For example, as in FIG. 7, clothes, a watch, a bag, a shoe, a car, a meal, and a visiting place are recognized from text or an image of posted information, and these attribute items and attribute data are added (updated) to the cyber attribute information. For example, brands of clothes, a watch, a bag, and a shoe, a car manufacturer, a type of meal, and the like are recognized from a feature of an image or a keyword of text (comment) included in posted information, and a visiting place is acquired from Global Positioning System (GPS) information or a keyword of text given to the image, and attribute data are generated. For example, information for classifying attributes (high-level, casual, etc.) of a brand may be held in advance, and attribute data associated to the brand may be generated based on the information. These pieces of attribute information may be extracted not only from the posted information, but also from the profile information or the like. Further, these pieces of attribute information are examples, and other pieces of attribute information (e.g., a book, a movie, music, a game, home appliances, stationery, daily necessities, cosmetics, etc.) may be extracted from the posted information.

Next, the cyber attribute extraction unit 102 determines whether the analysis of the account information of all the accounts has been completed (S205), and repeats the processing on and after S201 until the cyber attribute information of all the accounts is extracted. Since the cyber attribute information extracted from all the social media information is a large amount of information, information of several accounts may be grouped together. For example, the social media information (account information) may be classified into a plurality of clusters, and cyber attribute information may be generated (aggregated) for each cluster. For example, clustering may be performed according to a similarity between the profile information of the account information and the posted information.

As illustrated in FIG. 3, following the cyber attribute extraction processing (S102), the cyber-physical personal attribute matching device 100 acquires a video from the camera 300 (S103), and performs a physical attribute extraction processing (S104).

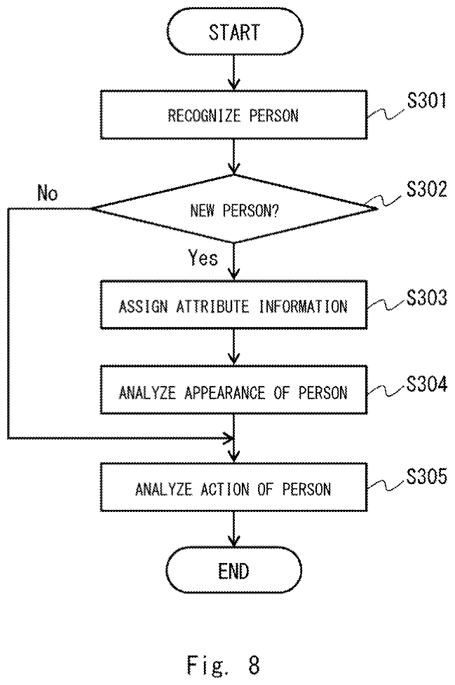

Specifically, the camera 300 constantly captures an image at an installation position such as in a store, and the camera video acquisition unit 104 acquires a video such as in a store from the camera 300. Further, the physical attribute extraction unit 105 executes physical attribute extraction processing, based on the acquired video. FIG. 8 illustrates a specific example of the physical attribute extraction processing.

As illustrated in FIG. 8, in the physical attribute extraction processing, first, the physical attribute extraction unit 105 recognizes a person in the acquired video (S301). For example, edge extraction processing is performed on a video (image) and a person is recognized from a pattern of the extracted edge. Next, the physical attribute extraction unit 105 determines whether or not the recognized person is a new person (S302). In order to determine whether or not the physical attribute information needs to be newly generated, it is determined whether or not the recognized person is a new person (a person who newly enters the shop). For example, when the physical attribute information is generated, an image of a person is held and determined by comparing the held image of the person with the image of the recognized person. When the similarity of the image is lower than a predetermined threshold value, it may be determined that the recognized person is a new person.

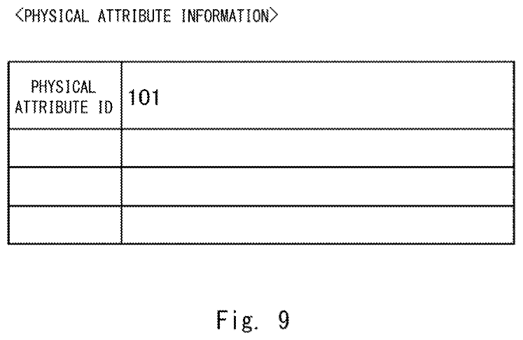

When it is determined that the recognized person is a new person, the physical attribute extraction unit 105 assigns attribute information for the new person (S303). For example, as in FIG. 9, physical attribute information is generated and a physical attribute ID is assigned thereto. The attribute items of the physical attribute information may not be set first, and be set according to the analysis result, or necessary items may be set in advance, in the same manner as the cyber attribute information. The attribute item set in the physical attribute information is associated with the cyber attribute information, and includes an attribute associated to a product of the store.

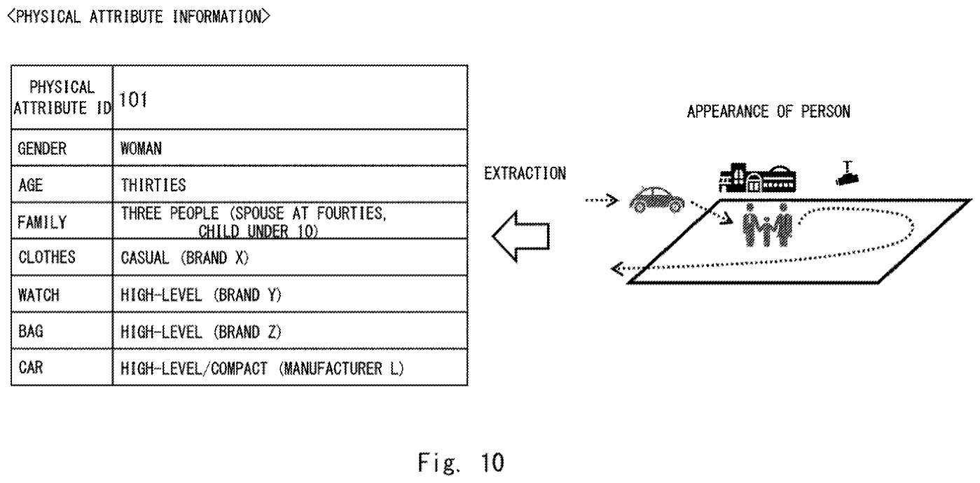

Next, the physical attribute extraction unit 105 analyzes an appearance of the recognized person (S304). The physical attribute extraction unit 105 extracts attribute items and attribute data by analyzing a video (image) of the recognized person. For example, as in FIG. 10, gender, age, family, clothes, a watch, a bag, and a car are recognized from the image of the person, and these attribute items and attribute data are added to the physical attribute information. For example, gender, age, and family are recognized from a contour of an image of a person, each brand of clothes, a watch, and a bag is recognized from a feature of an image of each part of the person, and a car manufacturer is recognized from a feature of an image of a car of the person, and attribute data are generated. Note that any attribute information may be extracted from either or both of the appearance and the action of the person.

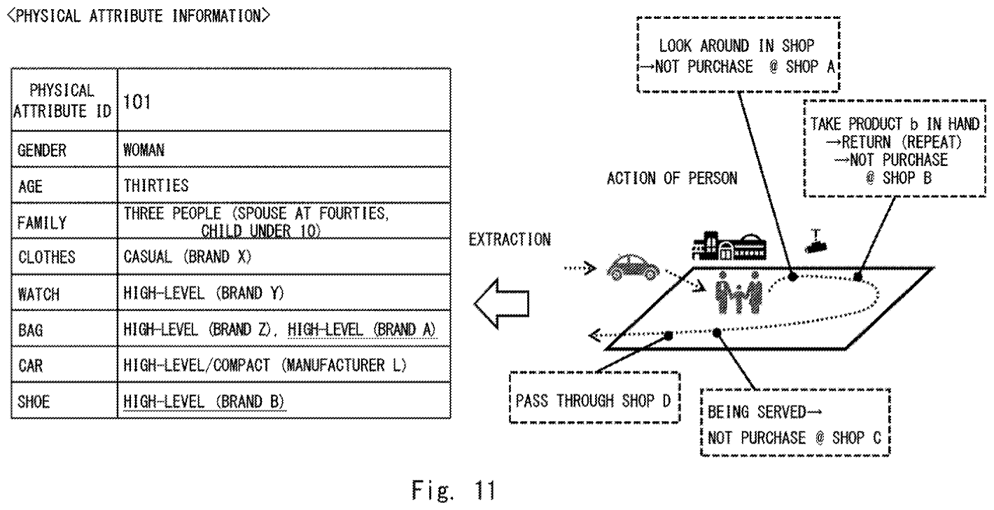

When it is determined that the recognized person is not a new person, or after analyzing the appearance of the person, the physical attribute extraction unit 105 analyzes an action of the person (S305). The physical attribute extraction unit 105 extracts attribute items and attribute data by analyzing an action of a person from a video of the recognized person. For example, as in FIG. 11, it is recognized that a person is interested in a bag or a shoe from a person's action, and these attribute items and attribute data are added (updated) to the physical attribute information. For example, when it is detected from a person's action that a person looks around in a bag shop A and a product has not been purchased, it can be determined that the person is interested in the product, and thus a brand of a bag viewed by the person is recognized, and information of the brand is added to attribute data of the bag. Further, when it is detected from a person's action that a person takes a product from a shelf at a shoe shop B, repeats returning the product to the shelf, and the product has not been purchased, it can be determined that the person is interested in the product, and thus, a brand of the shoe viewed by the person is recognized and brand information thereof is added to attribute data of the shoe. In addition, when a person is only served at a shop C and does not purchase a product, or when the person passes through a shop D, it can be determined that the person is not interested in the product, and thus, the attribute information is not extracted. Note that these pieces of attribute information are examples, and other pieces of attribute information may be extracted from an image or an action of a person in the same manner as the cyber attribute information.

As illustrated in FIG. 3, following the physical attribute extraction processing (S104), the cyber-physical personal attribute matching device 100 determines whether or not an event has occurred (S105), repeats the processing on and after S103 until the event occurs, and updates (adds) the physical attribute information. The event detection unit 107 detects occurrence of an event by analyzing an action of a person from a video of the person. For example, the event detection unit 107 detects occurrence of an event when a person approaches a display shelf of a product or a predetermined position in the vicinity of a sales hall, when the person stops therein, or the like.

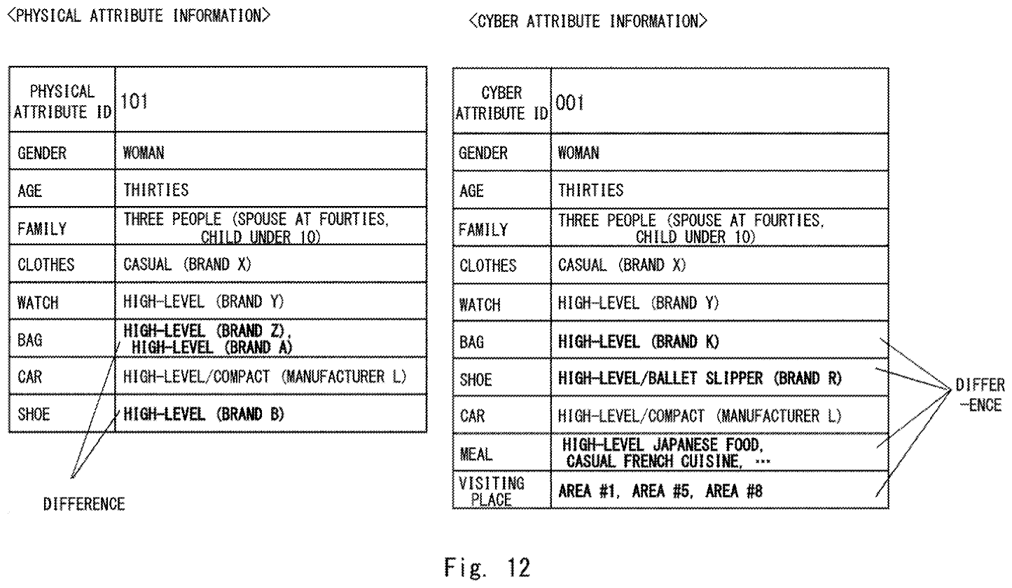

When it is determined that the event has occurred, the cyber-physical personal attribute matching device 100 calculates a degree of attribute agreement between the physical attribute information and the plurality of pieces of cyber attribute information (S106). The attribute agreement degree calculation unit 108 compares all the cyber attribute information extracted in the cyber attribute extraction processing (S102) with the physical attribute information of the person extracted in the physical attribute extraction processing (S104), and calculates the degree of attribute agreement. The attribute agreement degree calculation unit 108 compares attribute data in each attribute item of the physical attribute information and the cyber attribute information. For example, the degrees of agreement between attribute items (degrees of item agreement) are totaled and the total value may be set as the degree of attribute agreement. As an example, a degree of item agreement is acquired according to a ratio at which the attribute data in the attribute item match, and when the attribute data completely match, the degree of item agreement is set to 1.0. In the example of FIG. 12, when each attribute item of the physical attribute information is compared with each attribute item of the cyber attribute information, six attribute items of gender, age, family, clothes, a watch, and a car are agreed, and other attribute data are disagreed. For example, the item agreement degree 1.0×6=6.0 is set as the degree of attribute agreement.

Next, the cyber-physical personal attribute matching device 100 outputs related attribute information, based on the calculated degree of attribute agreement (S107). The related attribute information output unit 109 compares the cyber attribute information having the highest degree of attribute agreement with the physical attribute information, and outputs difference information and agreement information between the compared cyber attribute information and physical attribute information. Either the difference information or the agreement information may be output, or both may be output. In the example of FIG. 12, the attribute items of gender, age, family, clothes, a watch, and a car become the agreement information, and the attribute items of a bag, a shoe, a meal, and a visiting place become the difference information. For example, attribute data of the bag, the shoe, the meal, and the visiting place, which are the difference information, are output. The difference information may be attribute data of either the cyber attribute information or the physical attribute information, or may be attribute data of both. Further, the attribution data of the clothes, the watch, and the car, which are the agreement information, are output. A retailer can perform necessary sales promotion by using the attribute data of the difference and the agreement attribute data. It is preferable to delete the physical attribute after the related attribute information is output or after the person leaves the store.

As described above, in the present example embodiment, a degree of agreement between the physical attribute information of the person in the video acquired from the camera video and the plurality of pieces of the cyber attribute information of persons (users) acquired from the social media accounts is calculated, and the comparison result of the attribute information is output for a pair of the cyber attribute information having a high degree of agreement and the physical attribute information. As a result, it is possible to acquire a personal attribute of the cyberspace most related to a person (customer) who enters an actual store, and it is possible to appropriately recognize likes and tastes, interest, and the like of the customer. Namely, it is possible to perform 1-to-1 marketing optimized for each person in accordance with the likes and tastes, and interest. Furthermore, such marketing can be achieved without identifying an individual. Further, a physical attribute of the person in the video is extracted based on the action of the person, whereby the attribute of the person can be extracted in detail, and the cyber attribute suitable for the person in the real world can be recognized.

### Second Example Embodiment

Hereinafter, a second example embodiment will be described with reference to the drawings. In the present example embodiment, an example will be described in which, in the cyber-physical personal attribute matching device according to the first example embodiment, a degree of interest is given to each attribute information to be extracted, and a degree of attribute agreement is calculated in consideration of the given degree of interest.

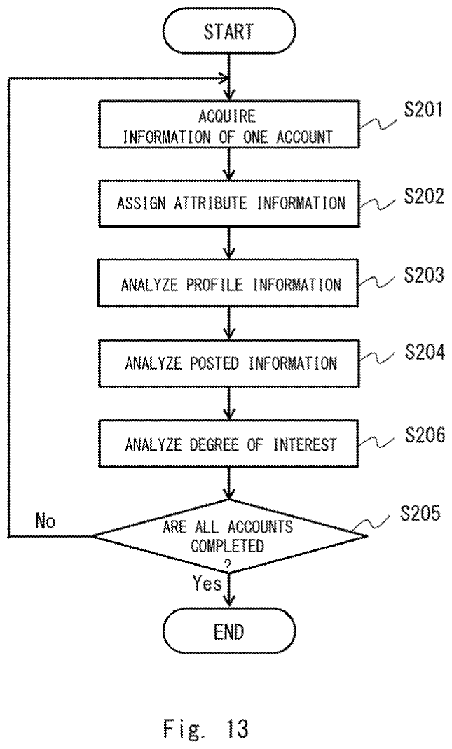

FIG. 13 illustrates a specific example of cyber attribute extraction processing according to the present example embodiment. In FIG. 13, interest degree analysis processing (S206) is added as compared with FIG. 4 of the first example embodiment, and others are the same as those of the first example embodiment.

Namely, in the present example embodiment, when the cyber attribute information is extracted from the acquired profile information and posted information of the account (S201 to S204), the cyber attribute extraction unit 102 analyzes a degree of interest of the extracted attribute information (S206). The cyber attribute extraction unit 102 analyzes the profile information, the text of the posted information, and the like, thereby calculating the degree of interest of the account (user) with respect to attribute data of each attribute item. For example, the degree of interest is set to −1.0 to +1.0 (negative to positive) depending on whether the user is interested (positive) or not interested (negative) in the attribute data.

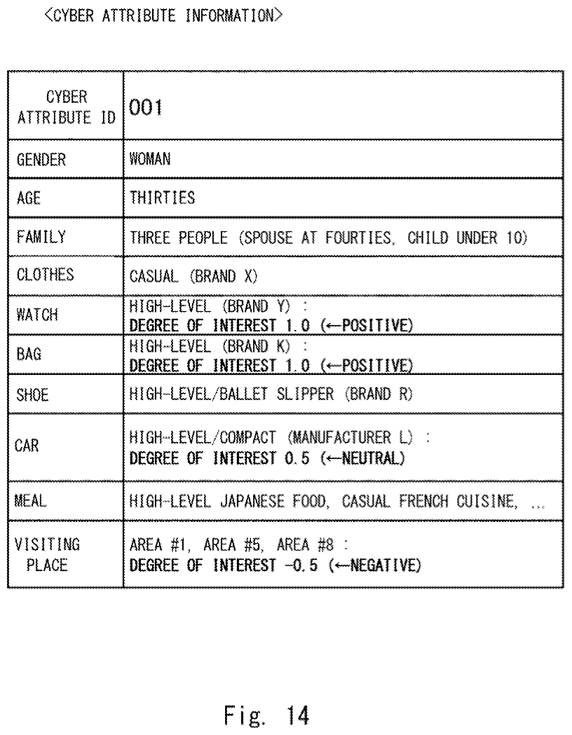

For example, in the example of FIG. 14, attribute items and attribute data of a watch and a bag are extracted from posted information, and it is determined that the posting is a positive content, from a keyword or a context analysis of a text (e.g., “I am glad that I bought it”, etc.) of the posted information about the watch and the bag, and the degree of interest is set to 1.0. Further, attribute items and attribute data of a car are extracted from the posted information, and it is determined that the posting is a neutral (neither positive nor negative) content, from a keyword and the context analysis of a text of the posted information about the car (e.g., “Not too good, not too bad.”, etc.), and the degree of interest is set to 0.5. In addition, attribute items and attribute data of a visiting place (area #8) are extracted from the posted information, and it is determined that the posting is a negative content, from a keyword or a context analysis of a text (e.g., “I do not want to go again”, etc.) of the posted information about the visiting place, and the degree of interest is set to −0.5.

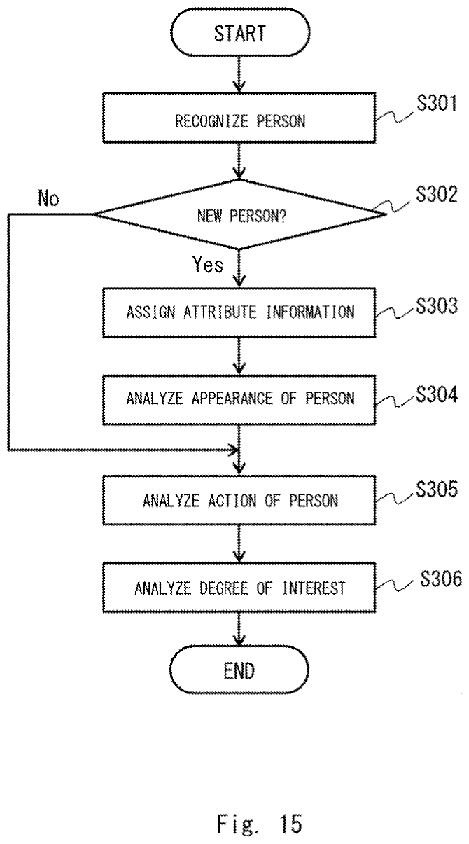

FIG. 15 illustrates a specific example of physical attribute extraction processing according to the present example embodiment. In FIG. 15, an interest degree analysis (S306) is added as compared with FIG. 8 of the first example embodiment, and others are the same as those of the first example embodiment.

Namely, in the present example embodiment, when the physical attribute information is extracted from an appearance and an action of a person in an acquired video (S301 to S305), the physical attribute extraction unit 105 analyzes a degree of interest of the extracted attribute information (S306). The physical attribute extraction unit 105 analyzes the appearance and behavior of the person, thereby calculating the degree of interest of the person with respect to the attribute data of each attribute item. For example, the degree of interest is set to −1.0 to +1.0 depending on whether or not a person is interested in the attribute data in the same manner as the cyber attribute information.

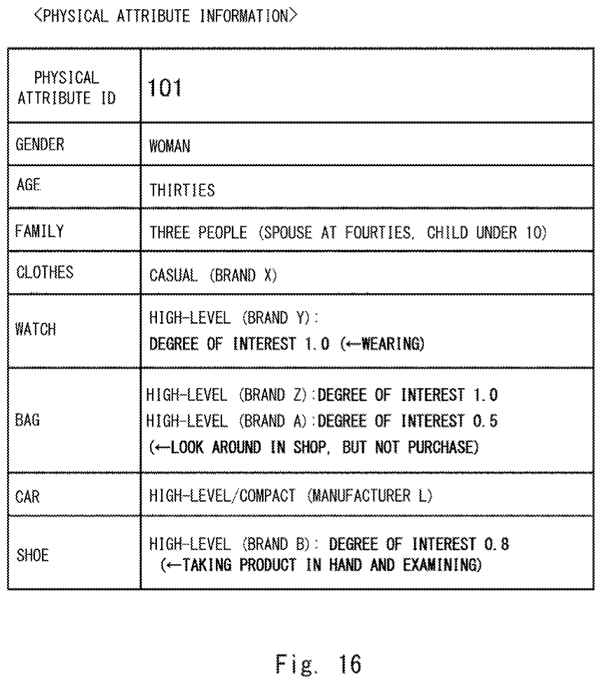

For example, in the example of FIG. 16, when an attribute item and attribute data of a watch are extracted from a video of a person and it is detected that the person wears the watch from the image analysis of the person, it is determined to be positive with respect to the watch, and the degree of interest is set to 1.0. Further, when an attribute item and attribute data of a bag (brand A) are extracted from the video of the person and it is detected that the person looks around in the shop from the behavior analysis of the person but does not purchase anything, it is determined to be neutral with respect to the bag, and the degree of interest is set to 0.5. In addition, when an attribute item and attribute data of a shoe are extracted from the video of the person and it is detected that the person has examined the product by taking the product in hand from the behavior analysis of the person, it is determined to be nearly positive with respect to the shoe, and the degree of interest is set to 0.8.

Thereafter, in the present example embodiment, the attribute agreement degree calculation unit 108 calculates a degree of attribute agreement by using the respective degrees of interest. As long as the degree of interest can be considered, the calculation method is not limited. For example, the degree of item agreement that is acquired by each attribute item may be multiplied by the degree of interest, or the degree of interest may be added thereto. In the examples of FIGS. 14 and 16, since the attribute data in the attribute item of the watch match, the degree of interest in the cyber attribute information is 1.0, and the degree of interest in the physical attribute information is 1.0, the degree of item agreement of the watch is set to 1.0×1.0×1.0=1.0. Also, since the attribute data in the attribute item of the car match and the degree of interest in the cyber attribute information is 0.5, the degree of item agreement of the car is set to 1.0×0.5=0.5. Further, similarly to the first example embodiment, a value acquired by totaling the respective degrees of item agreement is defined as the degree of attribute agreement between the cyber attribute information and the physical information. The related attribute information output unit 109 may output the comparison result including the degree of interest when outputting a comparison result.

As described above, in the configuration of the first example embodiment, the degree of attribute agreement may be further calculated in consideration of the degree of interest in each attribute. Accordingly, since the degree of attribute agreement between the cyber attribute information and the physical attribute information can be calculated according to the interest of the person, the comparison result of the attribute information can be acquired more appropriately.

In addition, when calculating the degree of attribute agreement, not only the degree of interest but also other parameters may be used. For example, in the cyber attribute extraction processing, an estimation accuracy for estimating the attribute item of the cyber attribute information from the social media information may be calculated, and in the physical attribute extraction processing, an estimation accuracy for estimating the attribute item of the physical attribute information from the video may be calculated, and the degree of attribute agreement may be calculated by using the estimation accuracy, in the same manner as the above-described degree of interest. The estimation accuracy is an accuracy (similarity, etc.) in which a product (brand) can be recognized from an image.

### Third Example Embodiment

Hereinafter, a third example embodiment will be described with reference to the drawings. In the present example embodiment, an example of calculating a degree of agreement between a plurality of pieces of physical attribute information and a plurality of pieces of cyber attribute information in the cyber physical personal attribute matching device according to the first or second example embodiment will be described.

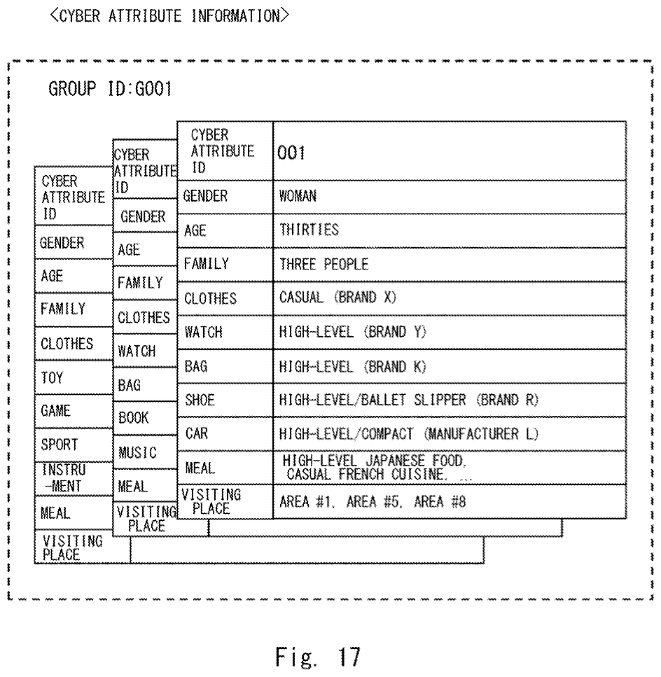

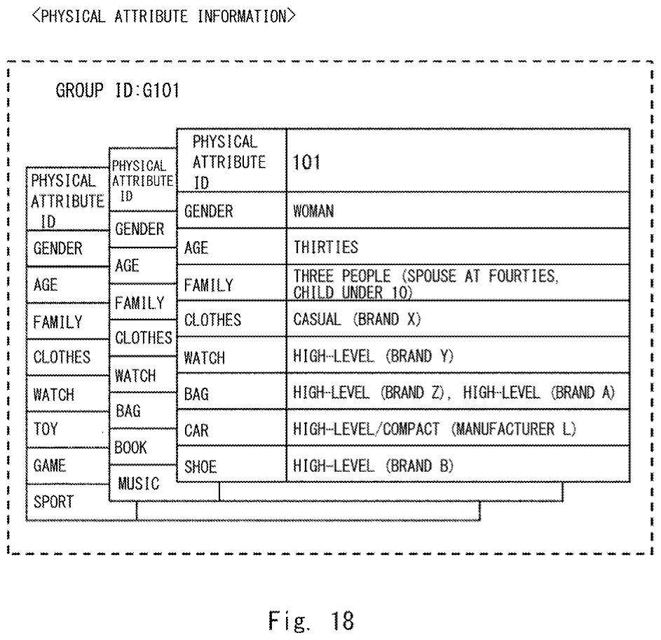

FIGS. 17 and 18 each illustrate a specific example of cyber attribute information and physical attribute information according to the present example embodiment. In the present example embodiment, a cyber attribute extraction unit 102 groups a plurality of pieces of cyber attribute information together as in FIG. 17. Namely, in cyber attribute extraction processing, cyber attribute information generated for each account is classified into groups, and a group ID is assigned to each classified group. The group is, for example, a family, a couple, friends, or the like. For example, a connection of the accounts is analyzed from profile information and posted information, and the group is determined.

As in FIG. 18, the physical attribute extraction unit 105 groups a plurality of pieces of physical attribute information together. Namely, in physical attribute extraction processing, physical attribute information generated for each person is classified into groups and a group ID is assigned to each classified group, in the same manner as the cyber attribute information. For example, from behavior analysis of persons, persons who act together for a certain period of time are defined as the same group.

Further, in the present example embodiment, the attribute agreement degree calculation unit 108 calculates the degree of attribute agreement for each group. A group of the cyber attribute information and a group of the physical attribute information are selected, and a degree of agreement of individual piece of attribute information included in each group is calculated. For example, the degrees of agreement of the individual pieces of attribute information in the group are totaled and acquire a degree of agreement in the attribute information of the group. In addition, a relationship between individual persons (accounts) in the group may be considered. For example, when persons (accounts) in the group purchase a product together, the degree of interest in an attribute item may be set high. Further, in the present example embodiment, the related attribute information output unit 109 selects a group having a high degree of attribute agreement, and outputs a comparison result of the attribute information between the groups.

As described above, in the configuration of the first or second example embodiment, the degree of agreement of the plurality of pieces of attribute information may be further calculated. As a result, in a case where the customer is a group such as a family member or a couple, the cyber attribute information in accordance with the group can be recognized, and the comparison result of the attribute information can be appropriately acquired.

### Fourth Example Embodiment

Hereinafter, a fourth example embodiment will be described with reference to the drawings. In the present example embodiment, an example in which the sales promotion assistance system according to the first to third example embodiments further includes a sales promotion processing device will be described.

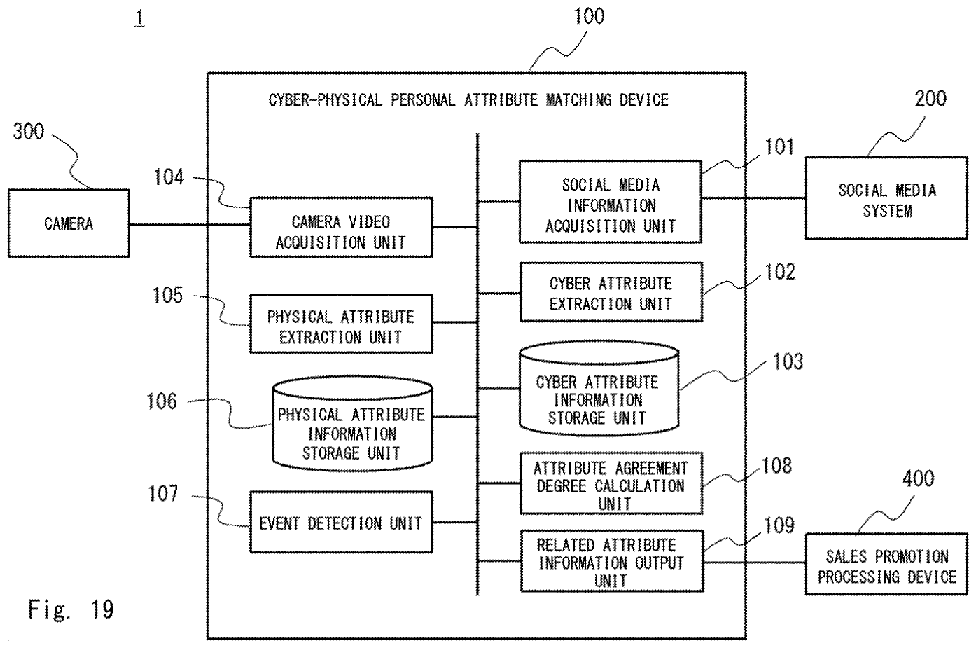

FIG. 19 illustrates a configuration example of the sales promotion assistance system according to the present example embodiment. In FIG. 19, a sales promotion processing device 400 is further provided as compared with FIG. 2 of the first example embodiment. The sales promotion processing device 400 executes sales promotion processing for a person in a video of a camera 300 according to related attribute information (a comparison result of attribute information) being output from a cyber-physical personal attribute matching device 100. The sales promotion processing is, for example, a process of displaying an advertisement or a coupon on a digital signage installed in the vicinity of a person in a store. For example, when difference information of the attribute information is output, an advertisement or a coupon of a product of a brand of the difference is displayed. In addition, when the agreement information of the attribute information is output, an advertisement or a coupon of another product related to the brand in agreement is displayed.

As described above, in the configurations of the first to third example embodiments, the sales promotion processing may be further performed. Accordingly, sales promotion can be reliably performed for a person in a real world according to a comparison result of cyber attribute information and physical attribute information.

The present disclosure is not limited to the above-described example embodiments, and can be appropriately modified without departing from the spirit of the present disclosure. For example, the above-described example embodiment may be applied not only to a store but also to other places (such as a taxi and a train).

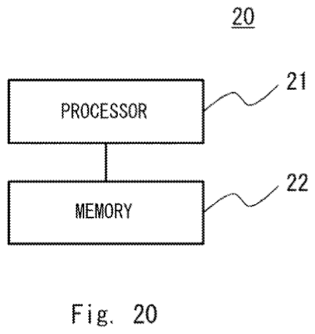

Each configuration in the above-described example embodiments is configured by hardware or software, or both, and may be configured by one hardware or software, or may be configured by a plurality of hardware or software. Each device and each function (processing) may be achieved by a computer 20 including a processor 21 such as a Central Processing Unit (CPU) and a memory 22 as a storage device, as illustrated in FIG. 20. For example, a program for performing a method (e.g., a matching method in a cyber-physical personal attribute matching device) in the example embodiment may be stored in the memory 22, and each function may be achieved by executing the program stored in the memory 22 by the processor 21.

These programs can be stored and provided to a computer by using various types of non-transitory computer-readable media. The non-transitory computer-readable media include various types of tangible storage media. Examples of the non-transitory computer-readable media include magnetic recording media (e.g., flexible disks, magnetic tapes, hard disk drives), magneto-optical recording media (e.g., magneto-optical disks), Read Only Memory (CD-ROM), CD-R, CD-R/W, and semi-conductor memory (e.g., mask ROM, Programmable ROM (PROM), Erasable PROM (EPROM), flash ROM, random access memory (RAM)). The program may also be provided to the computer by various types of transitory computer readable media. Examples of the transitory computer readable media include electrical signals, optical signals, and electromagnetic waves. The transitory computer readable medium can provide the program to the computer via a wired communication path such as an electric wire and an optical fiber, or a wireless communication path.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure.

Some or all of the above-described example embodiments may be described as the following supplementary notes, but are not limited thereto.

(Supplementary note 1)

A matching device comprising:

cyber attribute extraction means for extracting, based on social media information of a plurality of accounts, a plurality of pieces of cyber attribute information being personal attributes in a cyberspace of the plurality of accounts;

physical attribute extraction means for extracting, based on an image acquired by capturing a real world, physical attribute information being a personal attribute in a physical space of a person in the image;

calculation means for calculating a degree of agreement between the plurality of extracted cyber attribute information and the extracted physical attribute information; and

output means for comparing a piece of cyber attribute information selected based on the degree of agreement among the plurality of pieces of cyber attribute information with the physical attribute information, and outputting the compared result.

(Supplementary note 2)

The matching device according to Supplementary note 1, wherein the cyber attribute information and the physical attribute information include an attribute item related to sales promotion of a store in the real world.

(Supplementary note 3)

The matching device according to Supplementary note 2, wherein the image is an image captured by an imaging device installed in the store.

(Supplementary note 4)

The matching device according to any one of Supplementary notes 1 to 3, wherein the output means selects cyber attribute information having the highest degree of agreement.

(Supplementary note 5)

The matching device according to any one of Supplementary notes 1 to 4, wherein the output means outputs difference information regarding a difference between the cyber attribute information and the physical attribute information.

(Supplementary note 6)

The matching device according to any one of Supplementary notes 1 to 5, wherein the output means outputs agreement information regarding an agreement between the cyber attribute information and the physical attribute information.

(Supplementary note 7)

The matching device according to any one of Supplementary notes 1 to 6, wherein the cyber attribute extraction means extracts the cyber attribute information, based on profile information and posted information being included in the social media information.

(Supplementary note 8)

The matching device according to any one of Supplementary notes 1 to 7, wherein the cyber attribute extraction means classifies the plurality of pieces of social media information into a plurality of clusters and generates cyber attribute information for each of the clusters.

(Supplementary note 9)

The matching device according to any one of Supplementary notes 1 to 8, wherein

the cyber attribute extraction means calculates a degree of interest of the account with respect to the cyber attribute information, based on the social media information, and

the calculation means calculates the degree of agreement by using the degree of interest.

(Supplementary note 10)

The matching device according to any one of Supplementary notes 1 to 9, wherein

the cyber attribute extraction means calculates estimation accuracy of estimating an attribute item of the cyber attribute information from the social media information, and

the calculation means calculates the degree of agreement by using the estimation accuracy.

(Supplementary note 11)

The matching device according to any one of Supplementary notes 1 to 10, wherein the physical attribute extraction means extracts the physical attribute information, based on an appearance of a person and an action of a person that are recognized from the image.

(Supplementary note 12)

The matching device according to Supplementary note 11, wherein the physical attribute extraction means updates the physical attribute information according to an action of the person.

(Supplementary note 13)

The matching device according to any one of Supplementary notes 1 to 12, wherein

the physical attribute extraction means calculates a degree of interest of the person with respect to the physical attribute information, based on the image, and

the calculation means calculates the degree of agreement by using the degree of interest.

(Supplementary note 14)

The matching device according to any one of Supplementary notes 1 to 13, wherein

the physical attribute extraction means calculates estimation accuracy of estimating an attribute item of the physical attribute information from the image, and

the calculation means calculates the degree of agreement by using the estimation accuracy.

(Supplementary note 15)

The matching device according to any one of Supplementary notes 1 to 14, wherein the calculation means calculates a degree of agreement between cyber attribute information of a plurality of accounts and physical attribute information of a plurality of persons.

(Supplementary note 16)

The matching device according to Supplementary note 15, wherein

the cyber attribute extraction means extracts cyber attribute information of a plurality of accounts constituting a group, based on the social media information,

the physical attribute extraction means extracts physical attribute information of a plurality of persons constituting a group, based on the image, and

the calculation means calculates a degree of agreement between cyber attribute information of the group and physical attribute information of the group.

(Supplementary note 17)

A sales promotion assistance system comprising an imaging device installed in a store and a matching device,

wherein the matching device includes:

cyber attribute extraction means for extracting, based on social media information of a plurality of accounts, a plurality of pieces of cyber attribute information being personal attributes in a cyberspace of the plurality of accounts;

physical attribute extraction means for extracting, based on an image captured by the imaging device, physical attribute information being a personal attribute in a physical space of a person in the image;

calculation means for calculating a degree of agreement between the plurality of pieces of extracted cyber attribute information and the extracted physical attribute information; and

output means for comparing a piece of cyber attribute information selected based on the degree of agreement among the plurality of pieces of cyber attribute information with the physical attribute information, and outputting the compared result.

(Supplementary note 18)

The sales promotion assistance system according to Supplementary note 17, wherein the cyber attribute information and the physical attribute information include an attribute item related to sales promotion of the store.

(Supplementary note 19)

The sales promotion assistance system according to Supplementary note 17 or 18, further comprising a sales promotion processing device configured to execute sales promotion processing for the person according to the output comparison result.

(Supplementary note 20)

A matching method comprising:

extracting, based on social media information of a plurality of accounts, a plurality of pieces of cyber attribute information being personal attributes in a cyberspace of the plurality of accounts;

extracting, based on an image acquired by capturing a real world, physical attribute information being a personal attribute in a physical space of a person in the image;

calculating a degree of agreement between the plurality of pieces of extracted cyber attribute information and the extracted physical attribute information; and

comparing a piece of cyber attribute information selected based on the degree of agreement among the plurality of pieces of cyber attribute information with the physical attribute information, and outputting the compared result.

(Supplementary note 21)

The matching method according to Supplementary note 20, wherein the cyber attribute information and the physical attribute information include an attribute item related to sales promotion of a store in the real world.

(Supplementary note 22)

A non-transitory computer-readable medium storing a program for causing a computer to execute processing of:

extracting, based on social media information of a plurality of accounts, a plurality of pieces of cyber attribute information being personal attributes in a cyberspace of the plurality of accounts;

extracting, based on an image acquired by capturing a real world, physical attribute information being a personal attribute in a physical space of a person in the image;

calculating a degree of agreement between the plurality of pieces of extracted cyber attribute information and the extracted physical attribute information; and

comparing a piece of cyber attribute information selected based on the degree of agreement among the plurality of pieces of cyber attribute information with the physical attribute information, and outputting the compared result.

(Supplementary note 23)

The non-transitory computer-readable medium according to Supplementary note 22, wherein the cyber attribute information and the physical attribute information include an attribute item related to sales promotion of a store in the real world.

### REFERENCE SIGNS LIST

1 SALES PROMOTION ASSISTANCE SYSTEM
10 MATCHING DEVICE
11 CYBER ATTRIBUTE EXTRACTION UNIT
12 PHYSICAL ATTRIBUTE EXTRACTION UNIT
13 CALCULATION UNIT
14 OUTPUT UNIT
20 COMPUTER
21 PROCESSOR
22 MEMORY
100 CYBER-PHYSICAL PERSONAL ATTRIBUTE MATCHING DEVICE
101 SOCIAL MEDIA INFORMATION ACQUISITION UNIT
102 CYBER ATTRIBUTE EXTRACTION UNIT
103 CYBER ATTRIBUTE INFORMATION STORAGE UNIT
104 CAMERA IMAGE ACQUISITION UNIT
105 PHYSICAL ATTRIBUTE EXTRACTION UNIT
106 PHYSICAL ATTRIBUTE INFORMATION STORAGE UNIT
107 EVENT DETECTION UNIT
108 ATTRIBUTE AGREEMENT DEGREE CALCULATION UNIT
109 RELATED ATTRIBUTE INFORMATION OUTPUT UNIT
200 SOCIAL MEDIA SYSTEM
300 CAMERA
400 SALES PROMOTION PROCESSING DEVICE

What is claimed is:

1. A matching device comprising:
at least one memory storing instructions, and
at least one processor configured to execute the instructions stored in the at least one memory to;
extract, based on social media information of a plurality of accounts, a plurality of pieces of cyber attribute information being personal attributes in a cyberspace of the plurality of accounts;
extract, based on an image acquired by capturing a real world, physical attribute information being a personal attribute in a physical space of a person in the image;
calculate a degree of agreement between the plurality of extracted cyber attribute information and the extracted physical attribute information; and
compare a piece of cyber attribute information selected based on the degree of agreement among the plurality of pieces of cyber attribute information with the physical attribute information, and output the compared result.

2. The matching device according to claim 1, wherein the cyber attribute information and the physical attribute information include an attribute item related to sales promotion of a store in the real world.

3. The matching device according to claim 2, wherein the image is an image captured by an imaging device installed in the store.

4. The matching device according to claim 1, wherein the at least one processor is further configured to execute the instructions stored in the at least one memory to select cyber attribute information having the highest degree of agreement.

5. The matching device according to claim 1, wherein the at least one processor is further configured to execute the instructions stored in the at least one memory to output difference information regarding a difference between the cyber attribute information and the physical attribute information.

6. The matching device according to claim 1, wherein the at least one processor is further configured to execute the instructions stored in the at least one memory to output agreement information regarding an agreement between the cyber attribute information and the physical attribute information.

7. The matching device according to claim 1, wherein the at least one processor is further configured to execute the instructions stored in the at least one memory to extract the cyber attribute information, based on profile information and posted information being included in the social media information.

8. The matching device according to claim 1, wherein the at least one processor is further configured to execute the instructions stored in the at least one memory to classify the plurality of pieces of social media information into a plurality of clusters and generate cyber attribute information for each of the clusters.

9. The matching device according to claim 1, wherein the at least one processor is further configured to execute the instructions stored in the at least one memory to:
calculate a degree of interest of the account with respect to the cyber attribute information, based on the social media information, and
calculate the degree of agreement by using the degree of interest.

10. The matching device according to claim 1, wherein the at least one processor is further configured to execute the instructions stored in the at least one memory to:
calculate estimation accuracy of estimating an attribute item of the cyber attribute information from the social media information, and
calculate the degree of agreement by using the estimation accuracy.

11. The matching device according to claim 1, wherein the at least one processor is further configured to execute the instructions stored in the at least one memory to extract the physical attribute information, based on an appearance of a person and an action of a person that are recognized from the image.

12. The matching device according to claim 11, wherein the at least one processor is further configured to execute the instructions stored in the at least one memory to update the physical attribute information according to an action of the person.

13. The matching device according to claim 1, wherein the at least one processor is further configured to execute the instructions stored in the at least one memory to:
calculate a degree of interest of the person with respect to the physical attribute information, based on the image, and
calculate the degree of agreement by using the degree of interest.

14. The matching device according to claim 1, wherein the at least one processor is further configured to execute the instructions stored in the at least one memory to:
calculate estimation accuracy of estimating an attribute item of the physical attribute information from the image, and
calculate the degree of agreement by using the estimation accuracy.

15. The matching device according to claim 1, wherein the at least one processor is further configured to execute the instructions stored in the at least one memory to calculate a degree of agreement between cyber attribute information of a plurality of accounts and physical attribute information of a plurality of persons.

16. The matching device according to claim 15, wherein the at least one processor is further configured to execute the instructions stored in the at least one memory to:
extract cyber attribute information of a plurality of accounts constituting a group, based on the social media information,
extract physical attribute information of a plurality of persons constituting a group, based on the image, and
calculate a degree of agreement between cyber attribute information of the group and physical attribute information of the group.

17. A sales promotion assistance system comprising an imaging device installed in a store and the matching device according to claim 1,
wherein
the at least one processor is further configured to execute the instructions stored in the at least one memory to extract, based on an image captured by the imaging device, the physical attribute information.

18. The sales promotion assistance system according to claim 17, wherein the cyber attribute information and the physical attribute information include an attribute item related to sales promotion of the store.

19. (canceled)

20. A matching method comprising:
extracting, based on social media information of a plurality of accounts, a plurality of pieces of cyber attribute information being personal attributes in a cyberspace of the plurality of accounts;
extracting, based on an image acquired by capturing a real world, physical attribute information being a personal attribute in a physical space of a person in the image;
calculating a degree of agreement between the plurality of pieces of extracted cyber attribute information and the extracted physical attribute information; and
comparing a piece of cyber attribute information selected based on the degree of agreement among the plurality of pieces of cyber attribute information with the physical attribute information, and outputting the compared result.

21. (canceled)

22. A non-transitory computer-readable medium storing a program for causing a computer to execute processing of:
extracting, based on social media information of a plurality of accounts, a plurality of pieces of cyber attribute information being personal attributes in a cyberspace of the plurality of accounts;
extracting, based on an image acquired by capturing a real world, physical attribute information being a personal attribute in a physical space of a person in the image;
calculating a degree of agreement between the plurality of pieces of extracted cyber attribute information and the extracted physical attribute information; and
comparing a piece of cyber attribute information selected based on the degree of agreement among the plurality of pieces of cyber attribute information with the physical attribute information, and outputting the compared result.

23. (canceled)
